(19) United States
(12) Patent Application Publication
(10) Pub. No.: US 2013/0342783 A1
(43) Pub. Date: Dec. 26, 2013

(54) BACKLIGHT MODULE AND LCD DEVICE

(71) Applicants: Yicheng Kuo, Shenzhen (CN); Shihhsiang Chen, Shenzhen (CN); Gang Yu, Shenzhen (CN); Gege Zhou, Shenzhen (CN); Jiaqiang Wang, Shenzhen (CN)

(72) Inventors: Yicheng Kuo, Shenzhen (CN); Shihhsiang Chen, Shenzhen (CN); Gang Yu, Shenzhen (CN); Gege Zhou, Shenzhen (CN); Jiaqiang Wang, Shenzhen (CN)

(21) Appl. No.: 13/642,850

(22) PCT Filed: Jul. 9, 2012
(86) PCT No.: PCT/CN2012/078327

§ 371 Date: Oct. 22, 2012

(30) Foreign Application Priority Data
Jun. 21, 2012 (CN) 201210208019.6

(51) Int. Cl. F21V 8/00; G02F 1/1333; G02F 1/13357

(52) U.S. Cl. 349/58; 362/615; 349/62

(57) ABSTRACT

A backlight module includes a light guide panel (LGP), and a backplane. The LGP is arranged in the backplane, each side wall of the backplane is configured with a through hole(s), and the fixing pieces penetrate through the through holes and then fix the LGP. The fixing pieces are arranged on the side surface of the backplane of the present disclosure, and the fixing pieces are used for preventing the LGP from upward and downward moving in the vertical direction.

### TECHNICAL FIELD

The present disclosure relates to the field of liquid crystal displays (LCDs), and more particularly to a backlight module, and an LCD device.

### BACKGROUND

As shown in FIG. 1, a typical liquid crystal display (LCD) device generally includes a front frame 1, an LCD panel 2, a middle frame 3, a light guide panel (LGP) 4, a backplane 5 and the like. The LGP 4 is configured with optical film(s). The front frame 1, the middle frame 3 and the backplane 5 respectively have different functions. The front frame 1 is mainly used for fixing the LCD panel 2 and preventing the LCD panel 2 from escaping. The backplane 5 is mainly used for supporting the optical film, the LGP 4, the lightbar and the like. The middle frame 3 is mainly used for fixing the LGP 4, the optical film and the like together with the backplane 5, and used for supporting the LCD panel 2. A backlight module is formed by the backplane 5, the middle frame 3, and the LGP 4, the optical film, the lightbar and the like which are fixed by the backplane 5 and the middle frame 3.

The typical LGP is tightly pressed in the backplane by the middle frame, and the backlight module and the LCD panel are fixed by the front frame 1. As an intermediate product, the backlight module is also required to be transported. In the transportation process of the backlight module, the LGP is only fixed and limited by the middle frame. Because of the factors of assembly and part tolerance, the pressing force of the middle frame to the LGP is insufficient. Thus, in the transportation process of the backlight module, the LGP may be upward and downward moved and even tilted, thereby affecting the optical quality. Or, if the structure of the LCD device is expected to be simplified, and the middle frame is not arranged in the backlight module or the arranged middle frame does not play the role of fixing the LGP, it becomes a great problem to fix the LGP in the transportation process.

### SUMMARY

In view of the above-described problems, the aim of the present disclosure is to provide a backlight module, and a liquid crystal display (LCD) device. The light guide panel (LGP) of the backlight module is well fixed in the vertical direction, thereby ensuring that the LGP is not easily moved in the transportation process of the backlight module, and the backlight module has high optical quality.

A first technical scheme of the present disclosure is that: a backlight module comprises an LGP, and a backplane. The backplane comprise side walls. The LGP is arranged in the backplane. The backlight module further comprises fixing pieces; each side wall of the backplane is configured with a through hole(s), and the fixing pieces penetrate through the through holes and then fix the LGP.

In one example, the backlight module further comprises a middle frame. The middle frame is arranged above the LGP, and the middle frame comprises a plurality of member units. Gaps are set between the adjacent member units, and the fixing pieces are arranged between the adjacent member units of the middle frame.

In one example, the member units are frame corner members and are distributed on the four corners of the backplane. Or the member units are frame edge members and are distributed on the four edges of the backplane.

In one example, the member units are frame corner members and frame edge members. The frame corner members are distributed on the four corners of the backplane, and the frame edge members are distributed on the four edges of the backplane.

In one example, the fixing pieces are screws, rivets or pins.

In one example, the LGP is configured with grooves, and the groove is used for containing the fixing piece. The groove is a sinking step of an upper surface of the LGP. The fixing piece is arranged in the groove, thereby reducing the influence on the components above the LGP. The above components may adapt to the new structure change by only being slightly changed.

Advantages of the present disclosure are summarized below: the fixing pieces are arranged on the side surface of the backplane of the present disclosure, and the fixing pieces are used for preventing the LGP from upward and downward moving in the vertical direction, thereby ensuring that the LGP is not moved and tilted even in the severely required transportation process. Thus the optical quality of the backlight module is well ensured. Because of no need of playing the role of fixing the LGP and the optical film, the middle frame can be simplified into a sectioned structure and even can be removed, to simplify the structure of the LCD device.

The present disclosure further provides a second technical scheme: an LCD device comprises the backlight module mentioned above.

The present disclosure further provides a third technical scheme: an LCD device comprises an LGP, and a backplane. The backplane comprises side walls. The LGP is arranged in the backplane. Each side wall of the backplane is configured with a through hole(s), and the LGP is configured with grooves in the position corresponding to the through holes. The groove is a sinking step of the upper surface of the LGP.

In one example, the LCD device has no middle frame.

In one example, the LCD device further comprises a middle frame. The middle frame is arranged above the LGP, and the middle frame comprises a plurality of member units. Gaps are set between the adjacent member units, and the fixing pieces are arranged between the adjacent member units of the middle frame.

The aforementioned fixing pieces can only be used in the transportation process of the backlight module and can be removed when being assembled into the LCD device. The LGP can be pressed and fixed by other components above the LGP, such as LCD panel. Thus, each side wall of the backlight module is reserved with a through hole(s), and the LGP is reserved with groove(s).

### BRIEF DESCRIPTION OF FIGURES

FIG. 1 is a structure diagram of a typical LCD device;

FIG. 2 is a front view of a backlight module of a first example of the present disclosure;

FIG. 3 is a sectional view in the direction of A-A shown in FIG. 2;

FIG. 4 is a solid structure diagram of a backlight module of a second example of the present disclosure;

FIG. 5 is a partial sectional view of a backlight module of a second example of the present disclosure; and

FIG. 6 is a solid diagram of a third example of a backlight module of the present disclosure.

Legends: 1. front frame; 2. LCD panel; 3. middle frame; 31. frame corner member; 32. frame edge member; 4. LGP; 41. groove; 5. backplane. 6. fixing piece.

### DETAILED DESCRIPTION

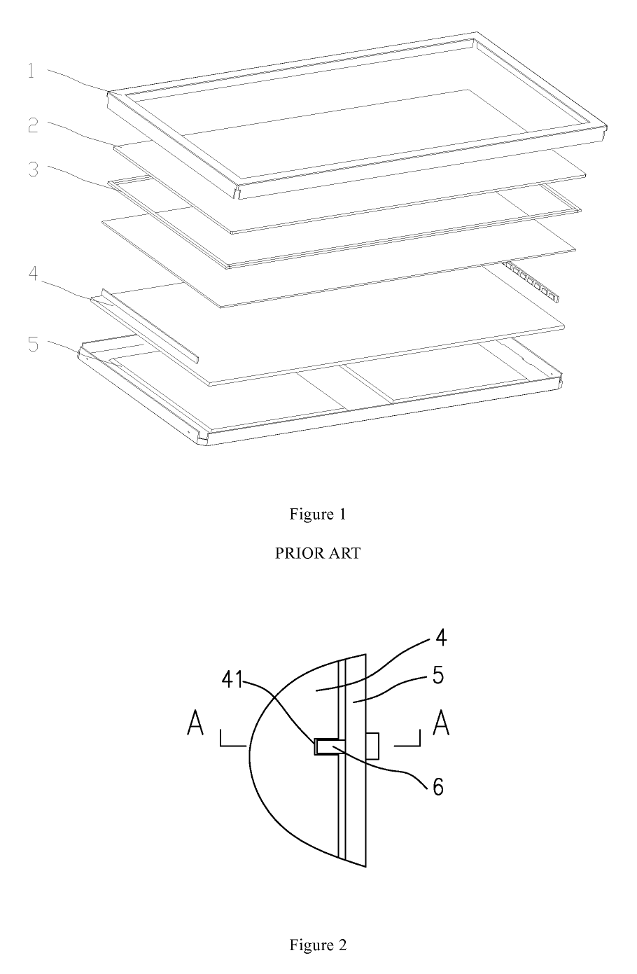

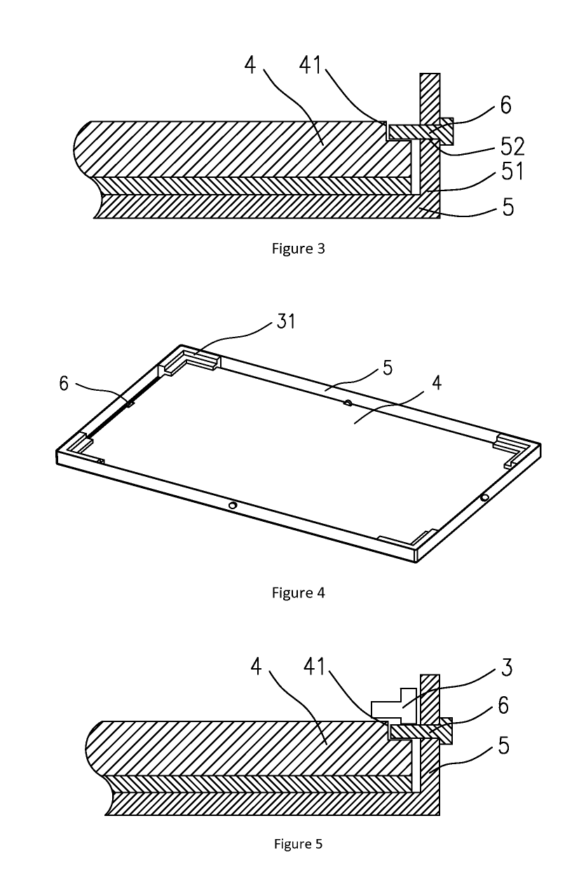

The present disclosure provides a liquid crystal display (LCD) device, comprising a backlight module. FIG. 2 and FIG. 3 show a first example of the backlight module of the present disclosure. The backlight module comprises a light guide panel (LGP) 4, and a backplane 5. The backplane 5 comprises side walls. The LGP 4 is arranged in the backplane 5. The backlight module further comprises fixing pieces 6, each side wall of the backplane 5 is configured with a through hole(s), and the fixing pieces 6 penetrate through the through holes to fix the LGP 4.

The fixing pieces 6 are arranged on the side surface of the backplane 5 of the present disclosure, and the fixing pieces 6 are used for preventing the LGP 4 from upward and downward moving in the vertical direction, thereby ensuring that the LGP 4 is not moved and tilted even in the severely required transportation process. Thus, the optical quality of the backlight module is well improved.

A part of backlight modules are not configured with middle frames any longer or the arranged middle frames do not play the role of fixing the LGP, the problems mentioned in the background such as insufficient pressing force of the LGP, even no pressing force, and upward and downward movement, and even tilt of the LGP in the transportation and use process, may be easy to occur. In the present disclosure, the fixing pieces are used for preventing the LGP from upward and downward moving in the vertical direction. The technical problems can still be well solved even if the middle frame is not arranged or the arranged middle frame does not play a role of fixing the LGP any longer.

In the example, the fixing pieces 6 are screws. Optionally, the fixing pieces 6 can be rivets, pins and the like. The number of the fixing pieces 6 is multiple, and the fixing pieces 6 are distributed on the four side walls of the backplane 5. The LGP 4 can obtain uniform fixing force. The fixing pieces can be freely arranged in accordance with the actual demand, can be arranged on the side wall of a single side of the backplane, and can be arranged on the side walls of multiple sides of the backplane as well.

In the example, the LGP 4 is configured with groove(s) 41, and the groove 41 is used for containing the fixing piece 6. The groove 41 is a sinking step of an upper surface of the LGP. The fixing piece 6 is arranged in the groove 41, thereby reducing the influence on the components above the LGP 4. The above components may adapt to the new structure change by only being slightly changed. As a scheme, the fixing piece 6 does not exceed the upper plane of the LGP 4, and the components above the LGP 4 do not need do any change. In addition, as an optimized scheme, the cross section of the groove 41 corresponds to the cross section of the fixing piece 6. The contact area between the fixing piece 6 and the LGP 4 is added, and the fixing force is dispersed, thereby reducing the influence on the optical quality of the LGP 4.

Optionally, in the example, the LGP may not be configured with grooves. The same advantage can also be achieved by directly contacting the fixing pieces with the upper surface of the LGP. Only the interference problem between the fixing pieces and other components needs to be solved. Or the side surface of the LGP is configured with blind holes, and the fixing pieces are inserted in the blind holes.

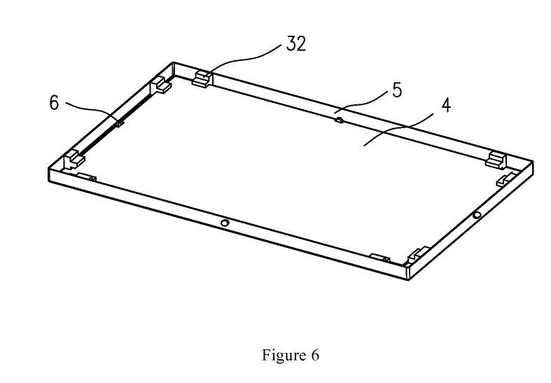

FIG. 4 and FIG. 5 show a second example of the backlight module of the present disclosure. The backlight module further comprises a middle frame 3. The middle frame 3 is arranged above the LGP 4, and the middle frame 3 comprises a plurality of member units. Gaps are set between the adjacent member units, and the fixing pieces 6 are arranged between the adjacent member units of the middle frame.

In the example, the member units are frame corner members 31, and are distributed on the four corners of the backplane 5. Because the middle frame 3 is of a sectioned structure, and gaps are set between the adjacent member units, there also exists a risk of insufficient fixing force of the LGP 4. The fixing pieces 6 arranged on the side surface of the backplane 5 directly extend from the side surface and fix the LGP 4, to prevent the LGP 4 from upward and downward moving in the vertical direction, thereby ensuring that the LGP 4 is not moved and tilted even in the severely required transportation process. Thus, the optical quality of the backlight module is well improved.

FIG. 6 shows a third example of the backlight module of the present disclosure, and the third example is different from the second example in that: the member units are frame edge member 32 and are distributed on the four edges of the backplane 5; gaps are set between all the adjacent member units. The number of the fixing pieces 6 is four, and the four fixing pieces 6 are respectively arranged on the four side walls of the backplane 5. Other structures and advantages of the example are consistent with those of the second example, and the example will not give unnecessary details.

Optionally, in all the above examples, the middle frame can be formed by frame corner members and frame edge members together. The frame corner members are distributed on the four corners of the backplane, the frame edge members are distributed on the four edges of the backplane, and the fixing pieces are distributed between adjacent member units, to fix the LGP.

As another example of the LCD device, the backlight module comprises an LGP, and a backplane; the backplane comprises side walls. The LGP is arranged in the backplane. Each side wall of the backplane is configured with a through hole(s), and the LGP is configured with a groove(s) in the position corresponding to the through holes. The groove is a sinking step of the upper surface of the LGP. The aforementioned fixing pieces can only be used in the transportation process of the backlight module and can be removed when being assembled into the LCD device. The LGP can be pressed and fixed by other component above the LGP, such as the LCD panel. Thus, each side wall of the backplane is reserved with a through hole(s), and the LGP is reserved with a groove(s). In the example, whether the LCD device does not use middle frame or uses sectioned middle frame, namely, the middle frame comprises a plurality of member units, gaps are set between all the adjacent member units, and the fixing pieces are arranged between the adjacent member units of the middle frame, both ways can ensure that the LGP is not moved in the transportation process, and then ensure that the backlight module has high optical quality.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A backlight module, comprising:
a light guide panel (LGP) arranged in a backplane,
a backplane comprising a side wall(s), and
a fixing piece(s);
wherein each side wall of the backplane is configured with a through hole(s), and the fixing pieces penetrate through the through holes and then fix the light guide panel (LGP).

2. The backlight module of claim 1, wherein the backlight module further comprises a middle frame; the middle frame is arranged above the LGP, and the middle frame comprises a plurality of member units; gaps are set between adjacent member units, and the fixing pieces are arranged between the adjacent member units of the middle frame.

3. The backlight module of claim 2, wherein the member units are frame corner members and are distributed on four corners of the backplane; or the member units are frame edge members and are distributed on four edges of the backplane.

4. The backlight module of claim 2, wherein the member units are frame corner members and frame edge members; the frame corner members are distributed on the four corners of the backplane, and the frame edge members are distributed on the four edges of the backplane.

5. The backlight module of claim 1, wherein the fixing pieces are screws, rivets or pins.

6. The backlight module of claim 1, wherein the LGP is configured with groove(s), and the groove is used for containing the fixing piece; the groove is a sinking step of an upper surface of the LGP.

7. A liquid crystal display (LCD) device, comprising:
a backlight module comprising a light guide panel (LGP), and a backplane;
wherein the backplane comprises a side wall(s), and the light guide panel (LGP) is arranged in the backplane; and
wherein the backlight module further comprises fixing pieces, each side wall of the backplane is configured with a through hole(s), and the fixing pieces penetrate through the through holes and then fix the light guide panel (LGP).

8. The LCD device of claim 7, wherein the backlight module further comprises a middle frame; the middle frame is arranged above the LGP, and the middle frame comprises a plurality of member units; gaps are set between the adjacent member units, and the fixing pieces are arranged between the adjacent member units of the middle frame.

9. The LCD device of claim 8, wherein the member units are frame corner members and are distributed on the four corners of the backplane; or the member units are frame edge members and are distributed on the four edges of the backplane.

10. The LCD device of claim 8, wherein the member units are frame corner members and frame edge members; the frame corner members are distributed on the four corners of the backplane, and the frame edge members are distributed on the four edges of the backplane.

11. The LCD device of claim 7, wherein the fixing pieces are screws, rivets or pins.

12. The LCD device of claim 7, wherein the LGP is configured with groove(s), and the groove is used for containing the fixing piece; the groove is a sinking step of the upper surface of the LGP.

13. A liquid crystal display (LCD) device, comprising:
a light guide panel (LGP) arranged in a backplane, and
a backplane comprising a side wall(s);
wherein each side wall of the backplane is configured with a through hole(s), and the light guide panel (LGP) is configured with a groove(s) in the position corresponding to the through hole; the groove is a sinking step of the upper surface of the light guide panel (LGP).

14. The LCD device of claim 13, wherein the LCD device has no middle frame.

15. The LCD device of claim 13, wherein the LCD device further comprises a middle frame; the middle frame is arranged above the LGP, and the middle frame comprises a plurality of member units; gaps are set between the adjacent member units, and the fixing pieces are arranged between the adjacent member units of the middle frame.
